(19) United States
(12) Patent Application Publication
(10) Pub. No.: US 2026/0086439 A1
(43) Pub. Date: Mar. 26, 2026

(54) CAMERA ASSEMBLY AND VEHICLE

(71) Applicant: TRIPLE WIN TECHNOLOGY(SHENZHEN) CO LTD., Shenzhen (CN)

(72) Inventor: YUAN-HSU CHOU, New Taipei (TW)

(21) Appl. No.: 18/953,348

(22) Filed: Nov. 20, 2024

(30) Foreign Application Priority Data
Sep. 23, 2024 (CN) 202411322949.3

(51) Int. Cl. G03B 17/14; G03B 30/00

(52) U.S. Cl. CPC G03B 17/14; G03B 30/00

(57) ABSTRACT

Embodiments of the present disclosure relates to a camera assembly and a vehicle using the camera assembly. The camera assembly includes a first lens barrel, a second lens barrel, at least one lens, and a circuit board. The first lens barrel having a first accommodating cavity. The second lens barrel is connected to the first lens barrel. The lens is held by the first lens barrel and positioned within the first accommodating cavity. The lens is configured to receive image light. The circuit board is adhered to an end of the second lens barrel away from the first lens barrel. An absolute value of a difference between a coefficient of thermal expansion (CTE) of the second barrel and that of the circuit board is less than an absolute value of a difference between a CTE of the first barrel and that of the circuit board.

### FIELD

The subject matter herein generally relates to optical technology, specifically camera assembles and vehicles using the lenes.

### BACKGROUND

With the advancement of science and technology, the use of camera assembles in vehicles has become increasingly widespread, and there is a growing demand for higher pixel counts and performance from these lenses. To improve the quality of the camera assembles, an Active Alignment (AA) process is generally employed to focus the lenses within the camera assembles. After focusing using the AA process, AA adhesive is required to bond the lens barrel to the photosensitive chip on the Printed Circuit Board (PCB).

However, after focusing, the camera assembles must undergo prolonged environmental testing at high temperatures. Due to the differing coefficients of thermal expansion (CTE) of the lens barrel and the PCB, the deformation of the lens barrel and the PCB varies at elevated temperatures. This leads to changes in the overall dimensions of the camera assembles, affecting its focus distance and subsequently its overall optical performance.

Therefore, there is room for improvement in the art.

### BRIEF DESCRIPTION OF THE DRAWINGS

Implementations of the present disclosure will now be described, by way of embodiment, with reference to the attached figures.

FIG. 1 is a schematic structural diagram of a camera assembly according to an embodiment of the present disclosure.

FIG. 2 is an exploded view of the camera assembly in FIG. 1.

FIG. 3 is a schematic structural diagram of a camera assembly according to another embodiment of the present disclosure.

FIG. 4 is an exploded view of the camera assembly in FIG. 3.

FIG. 5 is a cross-sectional view of the camera assembly in FIG. 1.

FIG. 6 is a functional schematic diagram of a vehicle according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”.

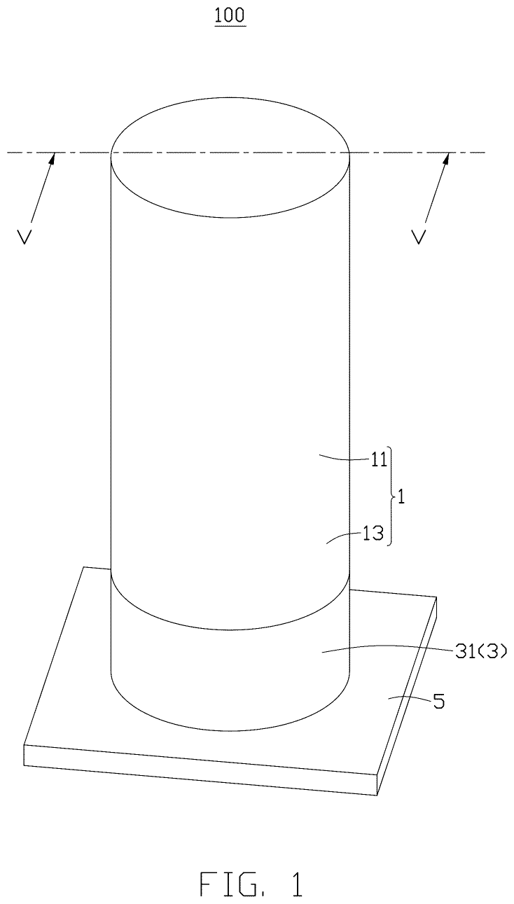

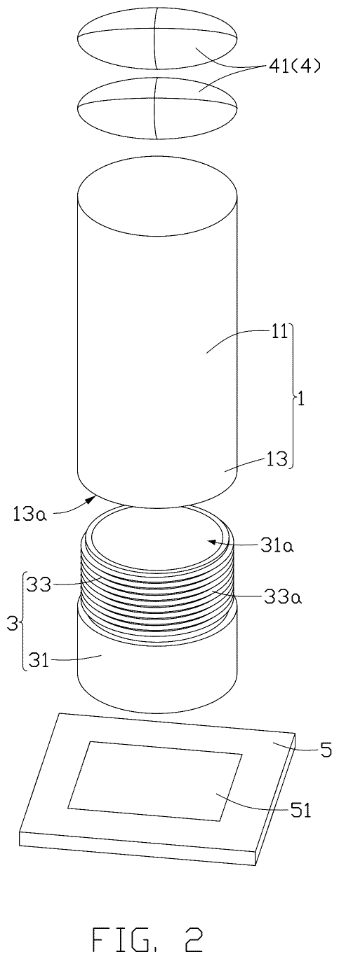

As shown in FIG. 1 and FIG. 2, a camera assembly 100 includes a first lens barrel 1 and a second lens barrel 3. The first lens barrel 1 having a first accommodating cavity 11a for accommodating lenses.

The first lens barrel 1 includes a first barrel body 11 and a first connecting portion 13 connected to an end of the first barrel body 11. The first accommodating cavity 11a is formed in the first barrel body 11. The first barrel body 11 and the first connecting portion 13 are integrally formed. The first connecting portion 13 is provided with an internal thread 13a for screwing with the second lens barrel 3.

In one embodiment, the first connecting portion 13 is substantially annular and connects to the entire end of the first barrel body 11 facing the second lens barrel 3. When the first connecting portion 13 is screwed to the second lens barrel 3, the first connecting portion 13 completely wraps around the end of the second lens barrel 3 close to the first connecting portion 13, thereby enhancing the stability of the connection between the first lens barrel 1 and the second lens barrel 3, and further compensating for any separation or deformation caused by temperature changes.

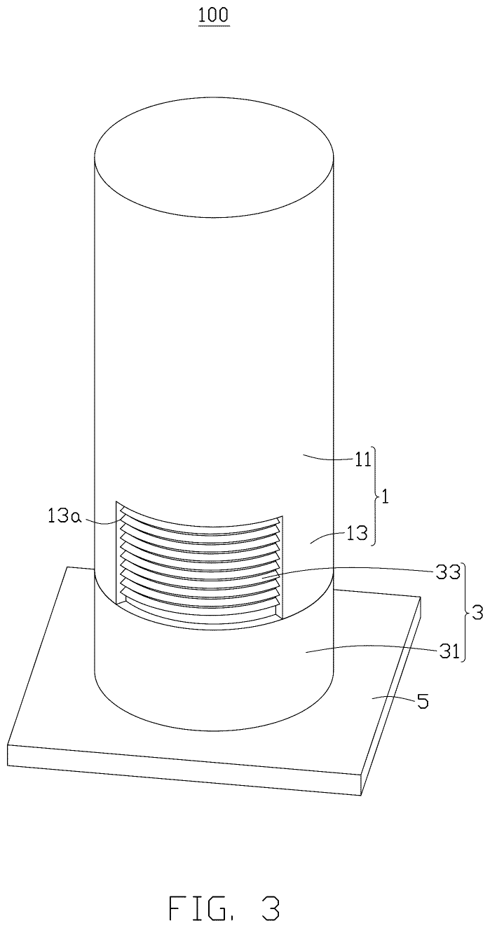

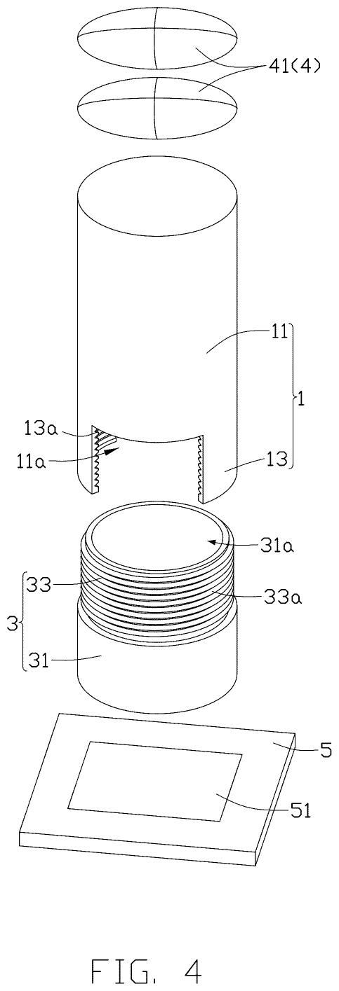

As shown in FIG. 3 and FIG. 4, the first lens barrel 1 include two first connecting portions 13 connected one end of the first barrel body 11 at intervals. Each first connecting portions 13 connects a portion of the first barrel body 11. The two first connecting portions 13 are arranged equidistantly at one end of the first barrel body 11. When the first connecting portions 13 are screwed to the second lens barrel 3, they do not completely wrap around the end of the second lens barrel 3 near the first connecting portions 13.

In other embodiments, the number of the first connecting portions 13 may be more than two.

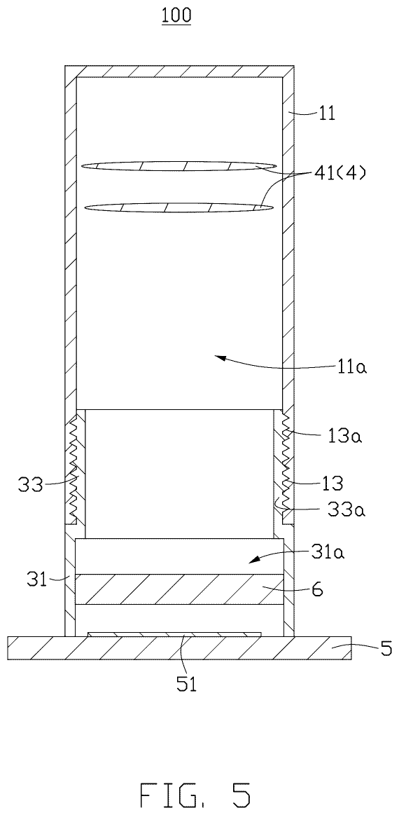

As shown in FIG. 2 and FIG. 5, a material of the first lens barrel 1 can be, but is not limited to, polycarbonate (PC), polyphenylene sulfide (PPS), or polyamide 9T.

Compared to traditional lens barrels, the first lens barrel 1 made of the above materials can still maintain effective strength and toughness at higher temperature, and has higher thermal stability, lower mold corrosiveness and higher lubricity, which is beneficial to reducing the cost of the camera assembly 100 while maintaining the high temperature resistance and high performance of the first lens barrel 1.

In other embodiments, the material of the first lens barrel 1 may be, but is not limited to, polyhexamethylene adipamide, polysebacamide, or polybutylene terephthalate.

The coefficient of thermal expansion of the first lens barrel 1 (hereinafter CTE1) is in the range of 60≤CTE1≤90. For example, the CTE1 of the first lens barrel 1 can be any value within the ranges of 60 to 65, 65 to 70, 70 to 75, 75 to 80, 80 to 85, or 85 to 90. The thermal expansion coefficient of the first lens barrel 1 is large, so when the temperature changes, the deformation of the first lens barrel 1 is large.

The second lens barrel 3 includes a second barrel body 31 and a second connecting portion 33 provided at one end of the second barrel body 31, which is close to the first barrel body 11. The second connecting portion 33 is used to connect with the first connecting portion 13. The end of the second barrel body 31, which is far from the second connecting portion 33, is used for bonding to a circuit board 5.

In one embodiment, the second connecting portion 33 has an external thread 33a for screw connection with the first connecting portion 13.

As shown in FIG. 2, the first connecting portion 13 has an annular inner side wall, the second connecting portion 33 has an annular outer side wall, the inner side wall is provided with the internal threads, the outer side wall is provided with external threads, and the external threads engage with the internal threads.

As shown in FIG. 3, the number of the first connecting portion 13 is multiple, the first connecting portions 13 are connected at intervals along a circumferential direction of the first barrel body 11. Each first connecting portion 13 an inner side wall shaped as a ring segment, the second connecting portion 33 has an annular outer side wall, the inner side wall is provided with the internal threads, the outer side wall is provided with external threads, the external threads engage with the internal threads, and parts of the external threads are exposed.

In other embodiments, the first connecting portion 13 and the second connecting portion 33 are bonded together.

The second lens barrel 3 has a second accommodating cavity 31a communicating with the first accommodating cavity 13a. The second accommodating cavity 31a is formed in the second barrel body 31.

The material of the second lens barrel 3 can be, but is not limited to, a plastic-fiberglass composite, metal, or ceramic. For instance, the material of the second lens barrel 3 may be, but is not limited to, a mixture of PC and 40 wt. % fiberglass or a mixture of PPS and 40 wt. % fiberglass.

The camera assembly 100 further includes an optical module 4, a circuit board 5, and a filter 6. The optical module 4 includes at least one lens 41. The at least one lens 41 is held by the first barrel body 11 and positioned within the first accommodating cavity 11a. The at least one lens 41 is used to receive image light. The lens 41 may be, but is not limited to, a convex lens, concave lens, polarized prism, free-form surface lens, or any other optical element capable of receiving light.

The filter 6 is in the second accommodating cavity 31a and is used to receive the image light emitted from the at least one lens 41.

The circuit board 5 is bonded to the end of the second barrel body 31 away from the second connecting portion 33. For example, the circuit board 5 may be bonded using ultraviolet curing adhesive at the end of the second barrel body 31 that is away from the second connecting portion 33.

The circuit board 5 includes a photosensitive chip 51, which is used to receive the image light passing through the filter and to form an image.

Additionally, the circuit board 5 further includes metal traces (not shown) and electronic devices (not shown).

The circuit board 5 contains various electronic devices, the thermal expansion coefficient of each device may be different. Since all devices are arranged on a side of the copper-clad board (not shown) of the circuit board 5, the coefficient of thermal expansion of the circuit board 5 (hereinafter CTE3) is influenced by the copper-clad board. The CTE3 of the circuit board 5 is generally in the range of 10-25. The CTE3 of the circuit board 5 is relatively small, so the deformation of the circuit board 5 is minor when the temperature changes.

The coefficient of thermal expansion of the second lens barrel 3 (hereinafter CTE2) is in the range of 10≤CTE2≤40. The CTE2 of the second lens barrel 3 can be any value within the ranges of 10 to 15, 15 to 20, 20 to 25, 25 to 30, 30 to 35, or 35 to 40. Since the second lens barrel 3 has a smaller coefficient of thermal expansion, so when the temperature changes, the deformation of the second lens barrel 3 is small.

The absolute value of the difference between the CTE2 of the second lens barrel 3 and the CTE3 of the circuit board 5 is less than the absolute value of the difference between the CTE1 of the first lens barrel 1 and the CTE3 of the circuit board 5. That is, the CTE2 of the second lens barrel 3 is closer to the CTE3 of the circuit board 5 compared to the CTE1 of the first lens barrel 1.

For example, the CTE1 of the first lens barrel 1 is 60, and the CTE of the circuit board 5 is either 10 or 25, then the CTE2 of the second lens barrel 3 is closer to the CTE3 of the circuit board 5 than the CTE1 of the first lens barrel 1.

Since the absolute value of the difference between the CTE2 of the second lens barrel 3 and the CTE3 of the circuit board 5 is less than the absolute value of the difference between the CTE1 of the first lens barrel 1 and the CTE3 of the circuit board 5, the deformation degree of the second lens barrel 3 at the same temperature is closer to that of the circuit board 5 than that of the first lens barrel 1. When the temperature changes, the second lens barrel 3 serves as a transitional component between the first lens barrel 1 and the circuit board 5, reducing the impact of the deformation of the first lens barrel 1 on the circuit board 5 during temperature changes, thus minimizing the size changes of the camera assembly 100 in response to temperature variations and providing a temperature compensation effect.

Additionally, the first connecting portion 13 is screwed with the second connecting portion 33 of the second lens barrel 3. When the first lens barrel 1 undergoes significant deformation due to temperature changes, part of this deformation can be offset due to the screw connection between the first lens barrel 1 and the second lens barrel 3. As a result, excessive deformation will not affect the connection between the first lens barrel 1 and the second lens barrel 3. Therefore, during temperature changes, it is beneficial to reduce the variation in the focus distance of the camera assembly 100, thus enhancing the stability of the overall optical performance of the camera assembly 100.

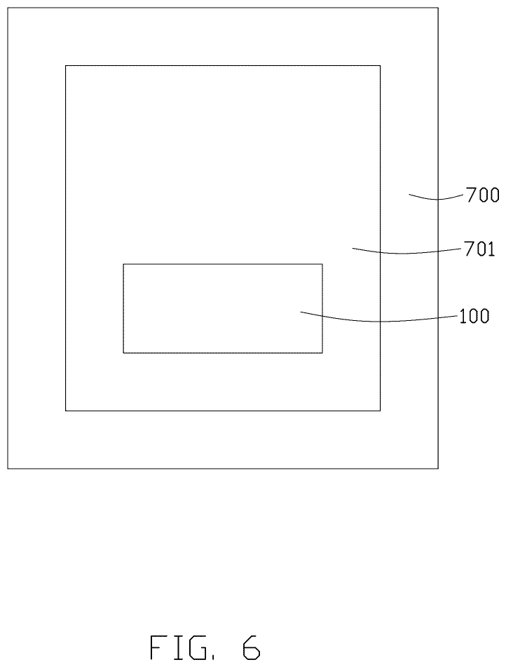

As shown in FIG. 2 and FIG. 6, a vehicle 700 includes a body 701 and the camera assembly 100. The camera assembly 100 is mounted on the body 701. The vehicle 700 may be an electric vehicle, gasoline vehicle, or diesel vehicle.

The camera assembly 100 may be a front-view lens, a surround view lens, a rear-view lens, a side view lens, or a built-in lens. For example, when the camera assembly 100 is a surround view lens, it is typically located around the vehicle body, usually in a quantity of 4 to 8, and specifically consists of a forward fisheye lens, left-side fisheye lens, right-side fisheye lens, and rearward fisheye lens. The surround view camera assembly 100 can be used to achieve panoramic surround view functionality and visual perception for parking assistance.

The vehicle 700 has at least the same advantages as the camera assembly 100 and will not be reiterated here.

It is to be understood, even though information and advantages of the present exemplary embodiments have been set forth in the foregoing description, together with details of the structures and functions of the present exemplary embodiments, the disclosure is illustrative only. Changes may be made in detail, especially in matters of shape, size, and arrangement of parts within the principles of the present exemplary embodiments to the full extent indicated by the plain meaning of the terms in which the appended claims are expressed.

What is claimed is:

1. A camera assembly, comprising:
a first lens barrel having a first accommodating cavity;
a second lens barrel having a second accommodating cavity communicating with the first accommodating cavity, and an end of the second lens barrel being connected to an end of the first lens barrel;
at least one lens held by the first lens barrel and positioned within the first accommodating cavity, and the at least one lens being configured to receive image light; and
a circuit board bonded to an end of second lens barrel away from the first lens barrel;
wherein an absolute value of a difference between a coefficient of thermal expansion (CTE) of the second barrel and a CTE of the circuit board is less than an absolute value of a difference between a CTE of the first barrel and the CTE of the circuit board.

2. The camera assembly according to claim 1, wherein the first lens barrel comprises a first barrel body and a first connecting portion connected to an end of the first barrel body, the first accommodating cavity is formed in the first barrel body;
the second lens barrel comprises a second barrel body and a second connecting portion connected to an end of the second cylinder, the second accommodating cavity is formed in the second barrel body, and the second connecting portion is connected to the first connecting portion;
the at least one lens is held by the first barrel body; and
the circuit board adhered to an end of the second barrel body away from the second connecting portion.

3. The camera assembly according to claim 2, wherein the first connecting portion is threadedly connected to the second connecting portion.

4. The camera assembly according to claim 3, wherein the first connecting portion has an annular inner side wall, the second connecting portion has an annular outer side wall, the inner side wall is provided with internal threads, the outer side wall is provided with external threads, and the external threads engage with the internal threads; or
a number of the first connecting portion is multiple, the first connecting portions are connected at intervals along a circumferential direction of the first barrel body, each first connecting portion an inner side wall shaped as a ring segment, the second connecting portion has an annular outer side wall, the inner side wall is provided with internal threads, the outer side wall is provided with external threads, the external threads engage with the internal threads, and parts of the external threads are exposed.

5. The camera assembly according to claim 1, wherein the CTE of the first lens barrel is greater than or equal to 60 and less than or equal to 90.

6. The camera assembly according to claim 5, wherein a material of the first lens barrel is polycarbonate, polyphenylene sulfide, or polyamide 9T.

7. The camera assembly according to claim 1, wherein the CTE of the second lens barrel is greater than or equal to 10 and less than or equal to 40.

8. The camera assembly according to claim 7, wherein a material of the second lens barrel is a plastic-glass fiber composite material, metal, or ceramic.

9. The camera assembly according to claim 8, wherein the material of the second lens barrel is a composite material of polycarbonate with 40 wt. % glass fiber or polyphenylene sulfide with 40 wt. % glass fiber.

10. The camera assembly according to claim 1, further comprising a filter is in the second accommodating cavity to receive the image light emitted from the at least one lens, wherein the circuit board comprises a photosensitive chip configured to receive the image light passing through the filter and to form an image.

11. A vehicle, comprising:
a body; and
a camera assembly mounted on the body, the camera assembly comprising:
a first lens barrel having a first accommodating cavity;
a second lens barrel having a second accommodating cavity communicating with the first accommodating cavity, and an end of the second lens barrel being connected to an end of the first lens barrel;
at least one lens held by the first lens barrel and positioned within the first accommodating cavity, and the at least one lens being configured to receive image light; and
a circuit board bonded to an end of second lens barrel away from the first lens barrel;
wherein an absolute value of a difference between a coefficient of thermal expansion (CTE) of the second barrel and a CTE of the circuit board is less than an absolute value of a difference between a CTE of the first barrel and the CTE of the circuit board.

12. The vehicle according to claim 11, wherein the first lens barrel comprises a first barrel body and a first connecting portion connected to an end of the first barrel body, the first accommodating cavity is formed in the first barrel body;
wherein the first lens barrel comprises a first barrel body and a first connecting portion connected to an end of the first barrel body, the first accommodating cavity is formed in the first barrel body;
the second lens barrel comprises a second barrel body and a second connecting portion connected to an end of the second cylinder, the second accommodating cavity is formed in the second barrel body, and the second connecting portion is connected to the first connecting portion;
the least one lens is held by the first barrel body; and
the circuit board adhered to an end of the second barrel body away from the second connecting portion.

13. The vehicle according to claim 12, wherein the first connecting portion is threadedly connected to the second connecting portion.

14. The vehicle according to claim 13, wherein the first connecting portion has an annular inner side wall, the second connecting portion has an annular outer side wall, the inner side wall is provided with an internal thread, the outer side wall is provided with an external thread, and the external thread engages with the internal thread; or
a number of the first connecting portion is multiple, the first connecting portions are connected at intervals along a circumferential direction of the first barrel body, each first connecting portion an inner side wall shaped as a ring segment, the second connecting portion has an annular outer side wall, the inner side wall is provided with an internal thread, the outer side wall is provided with an external thread, the external thread engages with the internal thread, and parts of the external thread are exposed.

15. The vehicle according to claim 11, wherein the CTE of the first lens barrel is greater than or equal to 60 and less than or equal to 90.

16. The vehicle according to claim 15, wherein a material of the first lens barrel is polycarbonate, polyphenylene sulfide, or polyamide 9T.

17. The vehicle according to claim 11, wherein the CTE of the second lens barrel is greater than or equal to 10 and less than or equal to 40.

18. The vehicle according to claim 17, wherein a material of the second lens barrel is a plastic-glass fiber composite material, metal, or ceramic.

19. The vehicle according to claim 18, wherein the material of the second lens barrel is a composite material of polycarbonate with 40 wt. % glass fiber or polyphenylene sulfide with 40 wt. % glass fiber.

20. The vehicle according to claim 11, further comprising a filter is in the second accommodating cavity to receive the image light emitted from the at least one lens, wherein the circuit board comprises a photosensitive chip configured to receive the image light passing through the filter and to form an image.
